(19) United States
(12) Patent Application Publication
(10) Pub. No.: US 2026/0179280 A1
(43) Pub. Date: Jun. 25, 2026

(54) GENERATIVE ARTIFICIAL INTELLIGENCE (AI) BASED IMAGE FRAME SEQUENCE AUGMENTATION

(71) Applicant: QUALCOMM Incorporated, San Diego, CA (US)

(72) Inventors: Michael Franco TAVEIRA, San Diego, CA (US); Seyfullah Halit OGUZ, San Diego, CA (US)

(21) Appl. No.: 19/051,075

(22) Filed: Feb. 11, 2025

Related U.S. Application Data
(60) Provisional application No. 63/737,904, filed on Dec. 23, 2024.

(51) Int. Cl. G06T 11/60

(52) U.S. Cl. CPC G06T 11/60

(57) ABSTRACT

A device includes a memory configured to store a sequence of captured image frames of a scene. The device also includes one or more processors coupled to the memory. The one or more processors are configured to use a generative artificial intelligence (AI) model to generate a first additional image frame based on a captured image frame of the sequence of captured image frames. The one or more processors are also configured to provide an output that includes an augmented sequence of image frames of the scene. The augmented sequence of image frames includes a plurality of the captured image frames and the first additional image frame.

### I. CROSS-REFERENCE TO RELATED APPLICATIONS

The present application claims priority from the commonly owned U.S. Provisional Patent Application No. 63/737,904, filed Dec. 23, 2024, entitled “GENERATIVE ARTIFICIAL INTELLIGENCE (AI) BASED IMAGE FRAME SEQUENCE AUGMENTATION,” the content of which is incorporated herein by reference in its entirety.

### II. FIELD

The present disclosure is generally related to image frame sequence augmentation.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture photos with a camera. As an example, a device capturing a dynamic image may capture a short video alongside each photo taken so that when an image is captured, 1.5 seconds of video before and 1.5 seconds of video after is captured. With 15 frames per second, each dynamic image includes 45 frames. A dynamic image is useful for selecting a good candidate image, especially in challenging situations involving subjects such as small children, pets, moving objects, or group photos. Sometimes those 45 frames (3 seconds) may fall short of capturing an acceptable photo. The perfect moment might be missed if someone starts to blink or move as the dynamic image is captured, or if someone starts to open their eyes just as the 3-second recording ends.

### IV. SUMMARY

According to one implementation of the present disclosure, a device includes a memory configured to store a sequence of captured image frames of a scene. The device also includes one or more processors coupled to the memory. The one or more processors are configured to use a generative artificial intelligence (AI) model to generate a first additional image frame based on a captured image frame of the sequence of captured image frames. The one or more processors are also configured to provide an output that includes an augmented sequence of image frames of the scene. The augmented sequence of image frames includes a plurality of the captured image frames and the first additional image frame.

According to another implementation of the present disclosure, a method includes obtaining, at a device, a sequence of captured image frames of a scene. The method also includes using, at the device, a generative artificial intelligence (AI) model to generate a first additional image frame based on a captured image frame of the sequence of captured image frames. The method also includes providing, at the device, an output that includes an augmented sequence of image frames of the scene. The augmented sequence of image frames includes a plurality of the captured image frames and the first additional image frame.

According to another implementation of the present disclosure, a non-transitory computer readable medium stores instructions that, when executed by one or more processors, cause the one or more processors to obtain a sequence of captured image frames of a scene. The instructions also cause the one or more processors to use a generative artificial intelligence (AI) model to generate a first additional image frame based on a captured image frame of the sequence of captured image frames. The instructions further cause the one or more processors to provide an output that includes an augmented sequence of image frames of the scene. The augmented sequence of image frames includes a plurality of the captured image frames and the first additional image frame.

According to another implementation of the present disclosure, an apparatus includes means for obtaining a sequence of captured image frames of a scene. The apparatus also includes means for using a generative artificial intelligence (AI) model to generate a first additional image frame based on a captured image frame of the sequence of captured image frames. The apparatus further includes means for providing an output that includes an augmented sequence of image frames of the scene, wherein the augmented sequence of image frames includes a plurality of the captured image frames and the first additional image frame.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to perform generative AI based image frame sequence augmentation, in accordance with some examples of the present disclosure.

FIG. 2 is a diagram of an illustrative aspect of operations associated with performing generative AI based image frame sequence augmentation, in accordance with some examples of the present disclosure.

FIG. 3 is a diagram of an illustrative aspect of operations associated with performing generative AI based image frame sequence augmentation, in accordance with some examples of the present disclosure.

FIG. 4 is a diagram of an illustrative aspect of operations associated with performing generative AI based image frame sequence augmentation, in accordance with some examples of the present disclosure.

FIG. 5 is a diagram of an illustrative aspect of operations associated with performing generative AI based image frame sequence augmentation, in accordance with some examples of the present disclosure.

FIG. 6 is a diagram of an illustrative aspect of operations associated with performing generative AI based image frame sequence augmentation, in accordance with some examples of the present disclosure.

FIG. 7 is a diagram of an illustrative aspect of operations associated with performing generative AI based image frame sequence augmentation, in accordance with some examples of the present disclosure.

FIG. 8 is a diagram of an illustrative aspect of operations associated with performing generative AI based image frame sequence augmentation, in accordance with some examples of the present disclosure.

FIG. 9 is a diagram of an illustrative aspect of operations associated with performing generative AI based image frame sequence augmentation, in accordance with some examples of the present disclosure.

FIG. 10 is a diagram of a particular implementation of a method of performing generative AI based image frame sequence augmentation that may be performed by the system of FIG. 1, in accordance with some examples of the present disclosure.

FIG. 11 is a diagram of an illustrative aspect of operations associated with performing generative AI based image frame sequence augmentation, in accordance with some examples of the present disclosure.

FIG. 12 illustrates an example of an integrated circuit operable to perform generative AI based image frame sequence augmentation, in accordance with some examples of the present disclosure.

FIG. 13 is a diagram of a mobile device operable to perform generative AI based image frame sequence augmentation, in accordance with some examples of the present disclosure.

FIG. 14 is a diagram of a wearable electronic device operable to perform generative AI based image frame sequence augmentation, in accordance with some examples of the present disclosure.

FIG. 15 is a diagram of a mixed reality or augmented reality glasses device operable to perform generative AI based image frame sequence augmentation, in accordance with some examples of the present disclosure.

FIG. 16 is a diagram of a camera operable to perform generative AI based image frame sequence augmentation, in accordance with some examples of the present disclosure.

FIG. 17 is a diagram of a headset, such as a virtual reality, mixed reality, or augmented reality headset, operable to perform generative AI based image frame sequence augmentation, in accordance with some examples of the present disclosure.

FIG. 18 is a diagram of a first example of a vehicle operable to perform generative AI based image frame sequence augmentation, in accordance with some examples of the present disclosure.

FIG. 19 is a diagram of a second example of a vehicle operable to perform generative AI based image frame sequence augmentation, in accordance with some examples of the present disclosure.

FIG. 20 is a block diagram of a particular illustrative example of a device that is operable to perform generative AI based image frame sequence augmentation, in accordance with some examples of the present disclosure.

### VI. DETAILED DESCRIPTION

Typically, a dynamic image includes a plurality of frames (e.g., 45 frames) corresponding to a capture duration (e.g., 1.5 seconds) of video before a captured image, a capture duration (e.g., 1.5 seconds) of video after the captured image, or both. It should be understood that 45 frames corresponding to a dynamic image that includes a captured image, 1.5 seconds of image frames before the captured image, and 1.5 seconds of image frames after the captured image is provided as an illustrative example. In other examples, a dynamic image can include any number of image frames corresponding to various capture durations before a captured image, various capture durations after the captured image, or both. A dynamic image may enable users to capture short moments (e.g., 3 seconds) along with any motion and/or sound captured during that time. In addition, a dynamic image may be useful for selecting a good candidate image, which may be presented as a static image or thumbnail in a photo album much like a typical static image. However, the perfect moment might be missed in the 45 frames, for example, if someone starts to blink or move as the dynamic image is captured, or if someone starts to open their eyes just as the 3-second recording ends.

Systems and methods of performing generative AI based image frame sequence augmentation are disclosed. For example, an image sequence augmentor obtains a sequence of captured image frames from a camera. The image sequence augmentor uses a generative AI model to process at least one captured image frame to generate at least one additional image frame. The image sequence augmentor populates an augmented sequence of images to include at least one of the captured image frames and the at least one additional image frame.

In some examples, a set of captured image frames depicts a person with their eyes closed, and a set of generated additional image frames depicts the person with their eyes open or depicts a transition from closed to open eyes over multiple additional image frames. The augmented sequence of images can include the set of additional image frames, and optionally the set of captured image frames as an alternative.

In some other examples, the captured image frames can depict an activity (e.g., a person missing a basket while playing basketball) and the set of additional image frames can depict a modification to the activity (e.g., the person scoring the basket). In yet some other examples, the captured image frames can depict a scene (e.g., a person walking towards a door) and the image sequence augmentor can generate multiple sets of additional image frames, with each set corresponding to an alternative scenario that can be added to the scene (e.g., alternate depictions of what is behind the door).

The image sequence augmentor thus provides an augmented sequence of image frames that includes at least one AI generated additional image frame. A technical advantage of such an augmented sequence of image frames can be that the at least one additional image frame replaces of a portion of the captured scene or adds one or more scenarios to the captured scene.

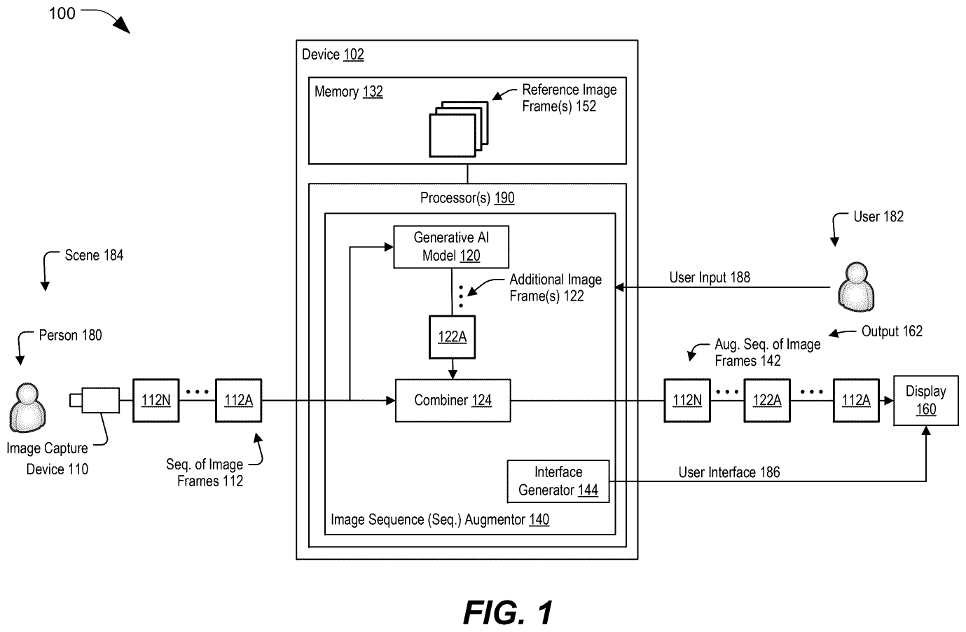

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple image frames are illustrated and associated with reference numbers 112A and 112N. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system configured to perform generative AI based image frame sequence augmentation is disclosed and generally designated 100. The system 100 includes a device 102 that is coupled to an image capture device 110 (e.g., a camera) and a display device 160. The device 102 includes one or more processors 190 coupled to a memory 132.

The one or more processors 190 include an image sequence (seq.) augmentor 140 that includes a generative artificial intelligence (AI) model 120, a combiner 124, an interface generator 144, or a combination thereof. In some aspects, the generative AI model 120 is integrated in a remote device (e.g., a network device), and the image sequence augmentor 140 is configured to receive images generated by the generative AI model 120 from the remote device.

The image capture device 110 is configured to output a sequence of image frames 112 of a scene 184. The image sequence augmentor 140 is configured to use the generative AI model 120 to process at least one of the image frames 112 to generate one or more additional image frames 122. Optionally, in some embodiments, the generative AI model 120 is configured to generate the one or more additional image frames 122 based on a target image frame. In some aspects, the target image frame includes a reference image frame 152 stored in the memory 132, an image frame 112 (e.g., a captured image frame), an additional image frame 122, or a combination thereof.

The combiner 124 is configured to use at least one image frame 112 and at least one additional image frame 122 to populate an augmented sequence of image frames 142. The image sequence augmentor 140 is configured to provide an output 162 that includes the augmented sequence of image frames 142. The output 162 may be stored in the memory 132 or provided to another device, such as the display device 160, a network device, a storage device, or a combination thereof.

The interface generator 144 is configured to output a user interface 186 to the display device 160 to enable receipt of a user input 188 from a user 182. In some aspects, the output 162 of the image sequence augmentor 140 may thus include the augmented sequence of image frames 142 and the user interface 186. The user input 188 may correspond to instructions, selections, etc. from the user 182. Optionally, in some embodiments, the generative AI model 120 is configured to generate the additional image frame(s) 122 based on a user input 188. Optionally, in some embodiments, the combiner 124 is configured to populate the augmented sequence of image frames 142 based on a user input 188. Optionally, in some embodiments, the interface generator 144 is configured to output the user interface 186 based on a user input 188.

The memory 132 is configured to store data used or generated by the image sequence augmentor 140. For example, the memory 132 is configured to store at least one of the sequence of image frames 112, one or more reference image frames 152, the additional image frame(s) 122, the augmented sequence of image frames 142, the user interface 186, the output 162, the user input 188, or a combination thereof.

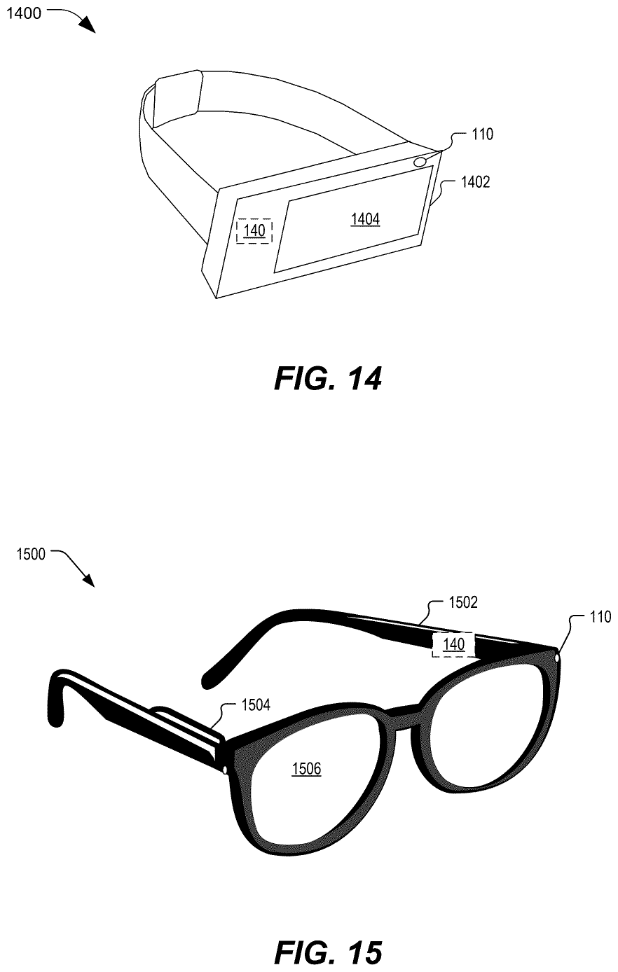

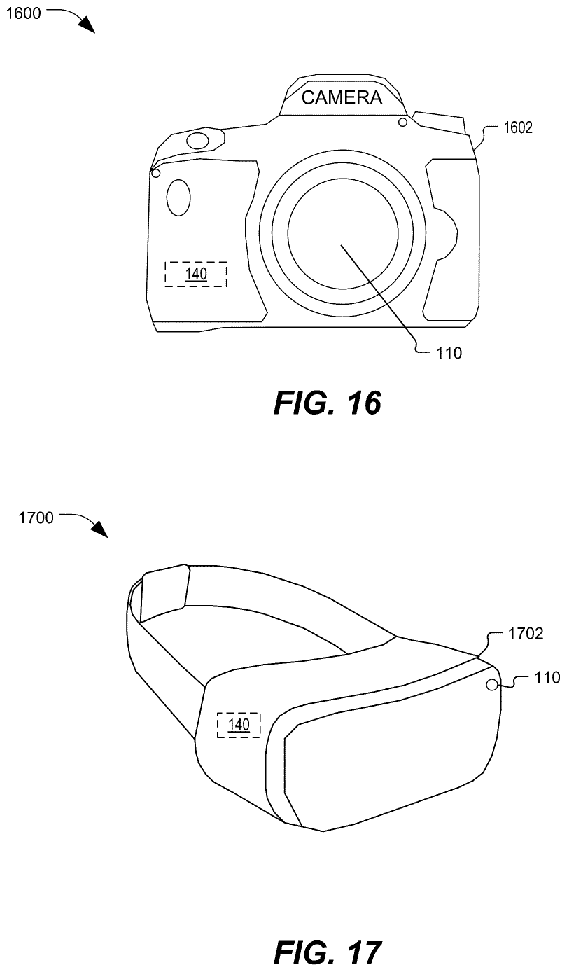

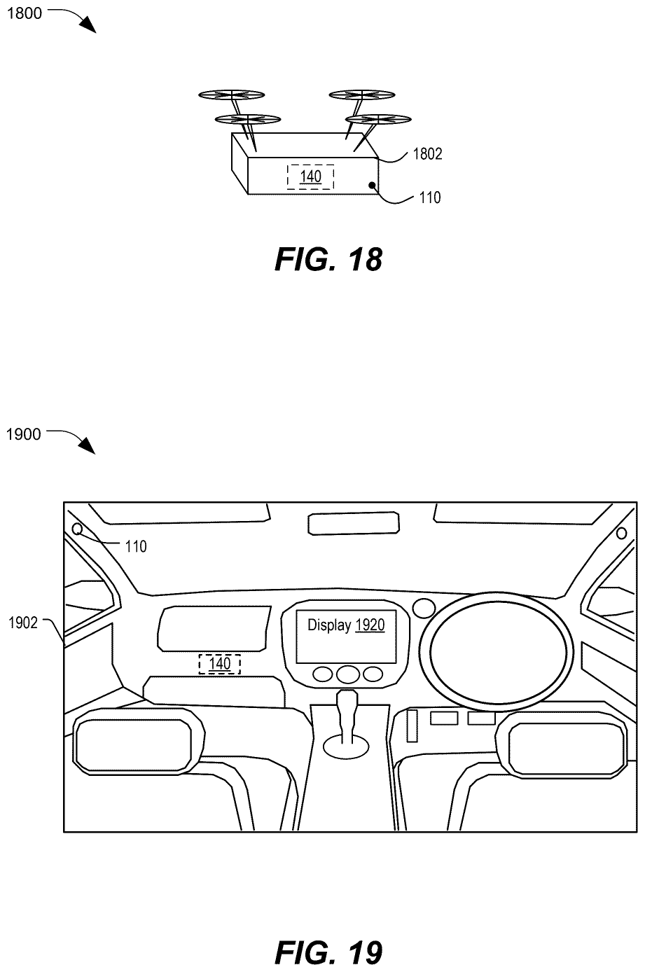

In some embodiments, the device 102 corresponds to or is included in one of various types of devices. In an illustrative example, the processor(s) 190 are integrated in a mobile phone or a tablet computer device, as described with reference to FIG. 13, a wearable electronic device, as described with reference to FIG. 14, a mixed reality or augmented reality glasses device, as described with reference to FIG. 15, a camera device, as described with reference to FIG. 16, or a virtual reality, mixed reality, or augmented reality headset, as described with reference to FIG. 17. In another illustrative example, the processor(s) 190 are integrated into a vehicle, such as described further with reference to FIG. 18 and FIG. 19.

During operation, the image sequence augmentor 140 obtains a sequence of image frames 112 (e.g., captured image frames) that represents a scene 184. In some examples, the scene 184 includes a person 180 performing an activity (e.g., playing a sport, walking, talking, posing, etc.). In various aspects, the sequence of image frames 112 is captured by the image capture device 110, received from a second device, generated by a component of the one or more processors 190, or a combination thereof.

Optionally, in some embodiments, the sequence of image frames 112 corresponds to a single image capture operation performed by the image capture device 110. To illustrate, the image sequence augmentor 140 receives a user input 188 at an input receipt time from a user 182 to initiate the capture of the scene 184 by the image capture device 110. A capture time interval of the image capture operation starts (e.g., 1.5 seconds) prior to the input receipt time and ends (e.g., 1.5 seconds) after the input receipt time. The sequence of image frames 112 includes an image frame 112A, one or more additional image frames, and an image frame 112N captured by the image capture device 110 during the capture time interval. Optionally, in some embodiments, the sequence of image frames 112 can include a first subset of image frames corresponding to a first capture time interval of a first image capture operation and a second subset of image frames corresponding to a second capture time interval of a second image capture operation.

Optionally, in some embodiments, the interface generator 144 provides a user interface 186 to the display device 160 to enable receipt of user instructions regarding generation of the augmented sequence of image frames 142. In a particular aspect, the scene 184 indicates an activity, and the user interface 186 includes a menu option to augment the sequence of image frames 112 to extend (e.g., extrapolate) the activity prior to the image frame 112A, a menu option to extend (e.g., extrapolate) the activity subsequent to the image frame 112N, a menu option to interpolate the activity between a pair of image frames 112, a menu option to modify the activity, or a combination thereof. For example, a first image frame captures a runner (e.g., a person 180) reaching a finish line and a second image frame captures the runner after passing the finish line. In this example, the user interface 186 can include a menu option to augment the sequence of image frames 112 to depict the person 180 running across the finish line (e.g., interpolation) or dancing across the finish line (e.g., modification). In some examples (e.g., automative or extended reality (XR) examples), the sequence of image frames 112 depict a person/car proceeding down a path (e.g., to a closed door or a roadway), and the user interface 186 can include a menu option to augment the sequence of image frames 112 to depict a possible continuation (e.g., predicted view on other side of open door or after different navigation choices) based on user preference, context, a predictability level (e.g., a randomness level, a plausibility level, or both), or a combination thereof. In some examples, the sequence of image frames 112 depict a person attempting to shoot a basketball with the image frames 112 ending before an outcome of the shot is captured, and the user interface 186 can include a menu option (or other input/selection mechanism) to augment the sequence of image frames 112 to depict a possible continuation, such as the basketball going into the basket or the basketball missing the basket.

In some aspects, the user interface 186 includes a target predictability input that a user can select to indicate a target level of predictability in the augmentation. To illustrate, the target predictability input can include a target randomness input (e.g., a slider, a number or value in a range of values, a knob, etc.) that a user can select to indicate a target level of randomness in the augmentation. For example, the target randomness input can be used to adjust between “highly probable” to “highly random.” For example, “highly probable” can correspond to a continuation of an activity without change (e.g., keep walking in the same direction in the next image frame), and “highly random” can correspond to a random continuation of an activity (e.g., turn in a random direction in the next image frame). In some embodiments, a target level of randomness is based on a user input 188, a configuration setting, a context, or a combination thereof.

In some examples, a target predictability input of the user interface 186 includes a target plausibility input (e.g., a slider, a number or value in a range of values, a knob, etc.) that a user can select to indicate a target level of plausibility in the augmentation. For example, “highly plausible” can correspond to image frame copy of a prior or subsequent image frame, “medium plausibility” can correspond to interpolation or extrapolation, “low plausibility” can correspond to modification that is somewhat plausible (e.g., dancing or jumping two inches higher), and “no plausibility” can correspond to modification that is implausible (e.g., levitating or jumping into space). In some embodiments, a target level of plausibility is based on a user input 188, a configuration setting, a context, or a combination thereof.

The image sequence augmentor 140 uses the generative AI model 120 to generate one or more additional image frames 122 based on at least one image frame 112 and optionally based on a user input 188, the target level of predictability, or a combination thereof. In some aspects, the user input 188 indicates user instructions, such as a prompt (e.g., “change the missed basket to a scored basket”). In an illustrative example, the image sequence augmentor 140 uses the generative AI model 120 to generate an additional image frame 122A, one or more additional image frames, or a combination thereof, that optionally correspond to the user instructions, the target level of predictability, or both.

In various examples, the image frames 112 depict a scene and the user input 188 indicates user instructions to modify the scene. For example, a first subset of the image frames 112 (e.g., frames 1-30) depicts a person shooting a basketball, a second subset of the image frames 112 (e.g., frames 31-45) depicts the basketball missing the basket, and the user instructions indicate that the scene is to be modified so that the basketball goes into the basket. The image sequence augmentor 140 uses the generative AI model 120 to generate additional image frames 122 that depict the basketball going into the basket. In some of these examples, the augmented sequence of image frames 142 includes the first subset of the image frames 112 (e.g., original frames 1-30) and the additional image frames 122 (e.g., as added frames 31-40) and does not include the second subset of the image frames 112 (e.g., original frames 31-45). The second subset of the image frames 112 (e.g., depicting the basketball missing the basket) is thus replaced with the one or more additional image frames 122 (e.g., depicting the basketball going into the basket) in the augmented sequence of image frames 142. To illustrate, replacement of the second subset of the image frames 112 can be considered as corresponding to the second subset of image frames 112 (e.g., original frames 31-45) not being captured (or being discarded), and the first subset of image frames 112 (e.g., original frames 1-30) being used to generate the additional image frames 122. In some examples, the augmented sequence of image frames 142 can include the second subset of image frames 112 (e.g., original frames 31-45) and the one or more additional image frames 122 (e.g., added frames 31-40) as alternative outcomes of the scene.

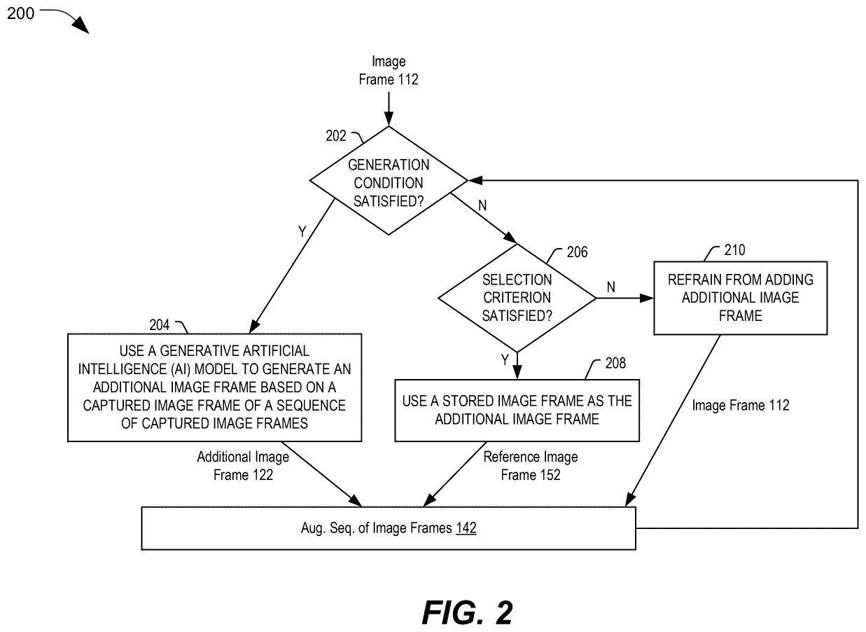

In some aspects, the image sequence augmentor 140 selectively uses the generative AI model 120 based on determining that a generation condition is satisfied, as further described with reference to FIG. 2. As an illustrative, non-limiting example, the generation condition can be based on one or more of a battery level, a network connectivity, a power connectivity, resource load, time of day (scheduled or otherwise), location, or another type of generation condition. In some examples, the image sequence augmentor 140, based on determining that no stored image frame satisfies a selection criterion to be used as an additional image frame, determines that the generation condition is satisfied.

In some aspects, the one or more additional image frames 122 correspond to an interpolation, an extrapolation, or a modification of an activity depicted in the sequence of image frames 112. In an example, an additional image frame 122 is to be added subsequent to a first image frame 112 of the sequence of image frames 112, prior to a second image frame 112 of the sequence of image frames 112, or both. In some embodiments, the image sequence augmentor 140 uses the generative AI model 120 to process at least the first image frame 112, the second image frame 112, or both, to generate the additional image frame 122. In some embodiments, the image sequence augmentor 140 uses the generative AI model 120 to process at least one previously generated additional image frame 122 to generate another additional image frame 122.

In some embodiments, the image sequence augmentor 140 uses the generative AI model 120 to process a first image frame that is to be included in the augmented sequence of image frames 142, a second image frame that is to be included in the augmented sequence of image frames 142, or both. The image sequence augmentor 140 populates the augmented sequence of image frames 142 to include the one or more additional image frames 122 subsequent to the first image frame, prior to the second image frame, or both. Generating the one or more additional image frames 122 based on the first image frame, the second image frame, or both, can result in a seamless transition between the one or more additional image frames 122 and other image frames of the augmented sequence of image frames 142. In some aspects, the first image frame includes a first image frame 112 (e.g., a captured image frame) or a first additional image frame 122 (e.g., a previously generated image frame). In some aspects, the second image frame includes a second image frame 112 (e.g., another captured image frame) or a second additional image frame 122 (e.g., another previously generated image frame).

In some examples, the generative AI model 120 applies a weight (e.g., indicated by the user input 188) to an image frame 112 (or a previously generated additional image frame 122) in generating the one or more additional image frames 122. For example, a higher weight gives more importance to a particular image frame (e.g., a user selected image frame) relative to other image frames (e.g., a next or previous frame) in generating the one or more additional image frames 122.

In some embodiments, the image sequence augmentor 140 uses the generative AI model 120 to also process one or more target image frames to generate the one or more additional image frames 122. A target image frame can include a reference image frame 152 (e.g., a stored image frame, such as one captured by the device 102 at a different time or capture event, by a second device, etc.), an image frame 112 (e.g., a captured image frame), an additional image frame 122 (e.g., an AI generated image frame), or a combination thereof. In some aspects, an image frame 112 depicts a captured object, a target image frame depicts a target object, and an additional image frame 122A depicts the captured object modified based on the target object.

In an example, eyes of the person 180 are not fully open (e.g., the captured object) in the sequence of image frames 112, a reference image frame 152 can correspond to an image of the person 180 captured at another time (e.g., by the same device 102 or a second device) with eyes fully open (e.g., the target object), and the image sequence augmentor 140 uses the generative AI model 120 to generate one or more additional image frames 122 of the person 180 in the scene 184 with eyes open (e.g., the modified object) based at least on the reference image frame 152. In some aspects, the additional image frame(s) 122 with the eyes open can be used to replace the image frame(s) 112 in which the person's eyes are not open in the augmented sequence of image frames 142. In some aspects, the image sequence augmentor 140 uses the generative AI model 120 to generate, based on the reference image frame 152, additional image frames 122 of the person 180 in the scene 184 transitioning from closed (or not fully open) eyes to fully open eyes. Further, the additional image frames 122 may also include a subset of additional image frames 122 where the eyes stay fully open.

In another example, a portion of the scene 184 (e.g., a fountain) is obstructed by an object (e.g., a car) in the sequence of image frames 112, a reference image frame 152 corresponds to an image of the portion of the scene 184 captured at another time, from another angle, or both, and the image sequence augmentor 140 uses the generative AI model 120 to process at least the reference image frame 152 to generate one or more additional image frame(s) 122 that depicts the scene 184 with the portion of the scene 184 unobstructed by the object. In some aspects, the image sequence augmentor 140 uses the generative AI model 120 to generate, based on the reference image frame 152, additional image frames 122 transitioning from the object obstructing the portion of the scene 184 to the portion of the scene 184 not being obstructed by the object (e.g., because the object is depicted as moving out of the way or because the viewing angle is changing).

In yet another example, the face of the person 180 (e.g., the captured object) is depicted in an image frame 112, a reference image frame 152 corresponds to an image of a cat (e.g., a target object), and the face of the person 180 turns into (e.g., transitions to) the face of the cat (e.g., the modified object) over a sequence of additional image frames 122. In some aspects, the image sequence augmentor 140 uses the generative AI model 120 to generate, based on the reference image frame 152, an additional image frame 122 in which the face of the person 180 is changed to the face of the cat.

In various aspects, the image sequence augmentor 140 uses the generative AI model 120 to generate one or more additional image frames 122 without a predetermined goal. For example, the image sequence augmentor 140 generates a next additional image frame 122 based on a previous additional image frame 122 without a predetermined goal or target. In other aspects, the image sequence augmentor 140 uses the generative AI model 120 to generate one or more additional image frames 122 to achieve a predetermined goal. For instance, the predetermined goal may be based on a target image frame (e.g., a target object), user instructions (e.g., a prompt), etc. For example, the image sequence augmentor 140 can use the generative AI model 120 to generate one or more additional image frames 122 based on a target image frame so that a captured object (e.g., a person with closed eyes) is depicted as transitioning to a target object (e.g., an image of the person with open eyes; a prompt requesting that the person's eyes be open; etc.).

In some aspects, the image sequence augmentor 140 generates a plan (e.g., as part of the predetermined goal) that indicates, for example (but not limited to), a count of additional image frames 122 to be generated to depict a transition (e.g., eyes opening), a duration of the transition (e.g., eyes take 0.5 seconds or 1 second to open), an amount of modification shown in each successive additional image frame 122 (e.g., a change in eye lid movement per additional image frame, such as 10% change in each frame or 10% in first frame, 20% in second frame, and so on), etc. In an illustrative example, the image sequence augmentor 140 performs the plan to achieve the predetermined goal. For example, the image sequence augmentor 140, to depict the person 180 with open eyes, determines that 7 additional image frames 122 are to be generated with each additional image frame 122 depicting a further transition of the eye lids moving. In some cases, the amount of transition may be equal (or approximately equal) in each additional image frame 122; in other cases, the amount of transition may vary from one additional image frame to another additional image frame. In further aspects, all additional image frames 122 (e.g., the 7 additional image frames 122) may be generated before all additional image frames 122 are presented to the user 182; in other aspects, each additional image frame 122 is individually displayed to the user 182 (e.g., the next additional image frame is generated responsive to user input).

In some aspects, the plan (e.g., generate 7 images to show complete eye-opening transition) is displayed to the user 182 before the images are generated (or before at least some of the images being generated). The user 182 can confirm or modify (e.g., can adjust to around 3 frames for a quicker, but potentially less natural transition, or more frames to provide more choices to the user 182). In some aspects, the image sequence augmentor 140 may obtain a plan or other guidance or input from the user 182 (e.g., “add 10 more frames for a subject to open their eyes”). The image sequence augmentor 140 may then, for instance, determine that the plan includes generating 10 frames, for example, each frame showing the eye 10% more open.

In various examples described herein, one or more of the additional image frames 122 may be added to the augmented sequence of image frames 142 as a replacement of one or more image frames 112, in addition to one or more image frames 112, or a combination thereof. To illustrate, the sequence of image frames 112 includes one or more image frames 112, and the augmented sequence of image frames 142 includes at least one image frame 112 and at least one additional image frame 122.

The combiner 124 populates an augmented sequence of image frames 142. For example, the combiner 124 adds the one or more additional image frames 122 to the sequence of image frames 112 to generate the augmented sequence of image frames 142. In some aspects, at least the additional image frame 122A is added between a pair of the image frames 112. In some aspects, at least one of the one or more additional image frames 122 can be added prior to the image frame 112A (e.g., an initial image frame of the sequence of image frames 112), at least one of the one or more additional image frames 122 can be added subsequent to the image frame 112N (e.g., a last image frame of the sequence of image frames 112), or both.

Optionally, in some aspects, the combiner 124 populates the augmented sequence of image frames 142 with all of the sequence of image frames 112 (e.g., corresponding to a single capture operation or multiple capture operations) and also adds at least one additional image frame 122. Alternatively, in some aspects, the combiner 124 uses at least one of the additional image frames 122 as a replacement for one or more of the image frames 112 in the augmented sequence of image frames 142. In various aspects, the augmented sequence of image frames 142 includes fewer than all of the image frames 112 and includes at least one additional image frame 122. The combiner 124 provides an output 162 that includes the augmented sequence of image frames 142.

Optionally, in some aspects, the image sequence augmentor 140 uses the generative AI model 120 to generate multiple additional image frames 122 based on at least one image frame 112. A subset of the sequence of image frames 112 corresponds to a particular scenario (e.g., missed a basket while playing basketball) associated with the scene 184. The multiple additional image frames 122 correspond to an alternative generated scenario (e.g., scored the basket) that can be added to the scene 184 to replace the particular scenario or a portion of the particular scenario (e.g., from the time the ball leaves the player's hand to the ball missing the basket). The augmented sequence of image frames 142 includes the multiple additional image frames 122 corresponding to the alternative scenario. In some embodiments, the output 162 also includes the subset of the sequence of image frames 112 corresponding to the originally captured scenario. In some aspects, the interface generator 144 provides the user interface 186 to the display device 160. The user interface 186 includes a first menu option to include the multiple additional image frames 122 and a second menu option to include the subset of the sequence of image frames 112. The image sequence augmentor 140, in response to receiving a user input 188 indicating a selection of a menu option, adds the corresponding image frames to the augmented sequence of image frames 142.

Optionally, in some examples, the image sequence augmentor 140 uses the generative AI model 120 to generate multiple sets of additional image frames 122 based on at least one image frame 112. Each set of additional image frames 122 corresponds to an alternative generated scenario that can be added to the scene 184 (e.g., the person 180 walking towards a door). In some embodiments, the augmented sequence of image frames 142 includes the multiple sets of additional image frames 122 corresponding to the alternative scenarios. The user 182 can select a particular set of additional image frames 122 to include in the augmented sequence of image frames 142. In some aspects, a first set of additional image frames 122 (e.g., an office behind the door in an office building) corresponds to high predictability (e.g., low randomness, highly plausible, or both), and a second set of additional image frames 122 (e.g., outer space behind the door) corresponds to low predictability (e.g., highly random, implausible, or both).

In some aspects, the output 162 (e.g., the user interface 186, metadata associated with the augmented sequence of image frames 142, or both) also include an AI attribution tag indicating that the augmented sequence of image frames 142 includes AI generated image frames. In some aspects, an additional image frame 122 includes an AI attribution tag indicating that the additional image frame 122 is an AI generated image frame. In some aspects, the output 162 indicates the user input 188 (e.g., user instructions), the target level of predictability (e.g., a target randomness, a target plausibility, or both), or a combination thereof used to generate at least one of the additional image frame 122 included in the augmented sequence of image frames 142.

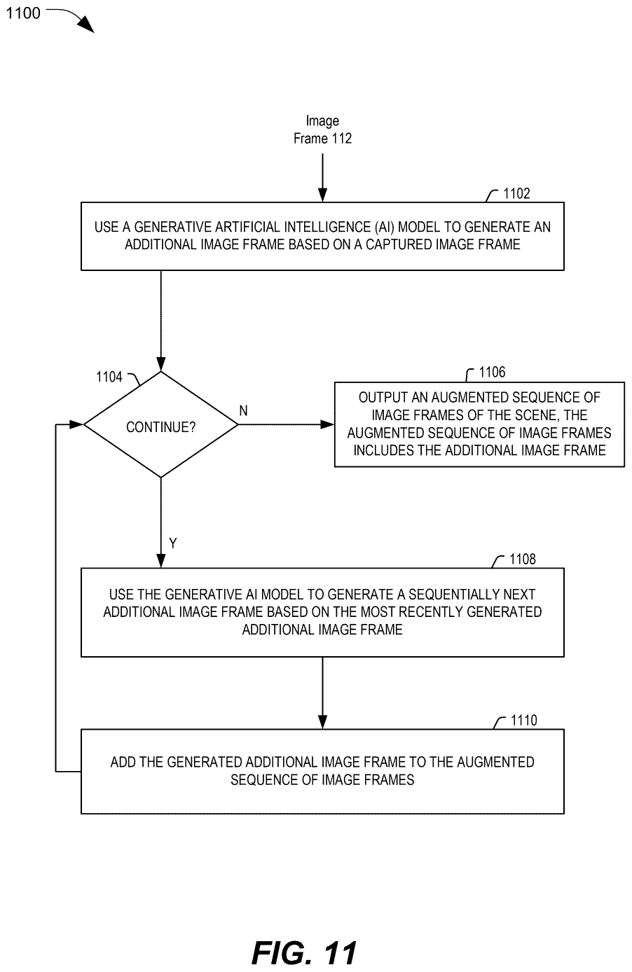

In some aspects, the image sequence augmentor 140 provides the output 162 to the display device 160. To illustrate, the combiner 124 provides the augmented sequence of image frames 142 to the display device 160 and the interface generator 144 provides the user interface 186 to the display device 160. In some aspects, the user 182 can use the user interface 186 to select an additional image frame 122 (e.g., with eyes open) to store in the memory 132 as a preferred image frame (e.g., a thumbnail or static image to display in a photo album or the like). In some aspects, the user 182 can use the user interface 186 to edit the augmented sequence of image frames 142 to include or exclude particular image frames. In some aspects, the user 182 can provide a user input 188 to continue generating additional image frames 122. To illustrate, the image sequence augmentor 140, in response to receiving the user input 188 to continue, uses the generative AI model 120 to process at least one of the augmented sequence of image frames 142 to generate an additional image frame 122 and adds the additional image frame 122 to the augmented sequence of image frames 142 in the output 162, as further described with reference to FIG. 11. In some examples, the user 182 may provide a user input 188 to generate an additional image frame 122 (e.g., frame N+11) and add the additional image frame 122 after the last generated additional image frame 122 (e.g., frame N+10), and may optionally add more additional image frames to increase the length of the augmented sequence of image frames 142 as desired. In other examples, the user 182 may provide a user input 188 to generate an additional image frame 122 (e.g., frame N+8′) and add the additional image frame 122 after a previously generated additional image frame 122 (e.g., frame N+7) to effectively replace some of the generated additional image frames 122 (e.g., frames N+8 and on). This enables a user to keep certain portions of the generated augmented sequence of image frames 142 and re-generate additional image frames 122 from the selected portions.

In some embodiments, the augmented sequence of image frames 142 has the same frame rate (e.g., 15 frames per second) as the sequence of image frames 112. In some embodiments, the sequence of image frames 112 has a first playout duration (e.g., 3 seconds) that is less than a second playout duration (e.g., 4 seconds) of the augmented sequence of image frames 142 (e.g., due to the augmented sequence of image frames 142 having the same frame rate, but more frames, than the sequence of image frames 112).

The system 100 thus enables augmenting the sequence of image frames 112 with one or more additional image frames 122 to generate the augmented sequence of image frames 142. The augmented sequence of image frames 142 can correspond to an interpolation, an extrapolation, a modification, or a combination thereof, of an activity depicted in the sequence of image frames 112. In some examples, the augmented sequence of image frames 142 can include one or more generated scenarios.

Although the generative AI model 120 is illustrated as included in the device 102, in other examples the generative AI model 120 can be integrated in a remote device and the image sequence augmentor 140 can receive one or more additional image frames 122 from the remote device. Although the image capture device 110 and the display device 160 are illustrated as external to the device 102, in some other examples the image capture device 110, the display device 160, or both, can be integrated in the device 102.

FIG. 2 is a diagram of an illustrative aspect of operations 200 associated with generative AI based image frame sequence augmentation that may be performed by the device 102 (e.g., the processor(s) 190) of FIG. 1, in accordance with some examples of the present disclosure.

At 202, the image sequence augmentor 140 of FIG. 1 determines whether a generation condition is satisfied. For example, the image sequence augmentor 140, responsive to receiving a next image frame (e.g., an image frame 112) of the sequence of image frames 112, determines whether the generation condition is satisfied based on a comparison of a battery level of the device 102 to a battery threshold, a detected network connectivity of the device 102, a detected power connectivity of the device 102, a comparison of a scheduled time and a detected time, or a combination thereof. In some aspects, the generation condition is based on user instructions, a target augmentation, or both. In an example, the image sequence augmentor 140, based on determining that the image frame 112 does not correspond to the target augmentation (e.g., does not include an object to be modified), determines that the generation condition is not satisfied.

The image sequence augmentor 140, in response to determining that the generation condition is satisfied, at 202, uses the generative AI model 120 to generate an additional image frame 122 based on at least in part on the image frame 112, as described with reference to FIG. 1, at 204, provides the additional image frame 122 to the combiner 124, and the combiner 124 adds the additional image frame 122 to an augmented sequence of image frames 142.

Alternatively, the image sequence augmentor 140, in response to determining that the generation condition is not satisfied, at 202, determines whether a selection criterion is satisfied, at 206. For example, the image sequence augmentor 140 determines whether a reference image frame 152 (e.g., a stored image frame depicting the person 180 with eyes open) satisfies the selection criterion (e.g., depicts the same location as the scene 184 at another time) to be used as an additional image frame corresponding to the image frame 112. In some examples, the selection criterion is based on user instructions, a target augmentation (e.g., change closed eyes to open eyes), or both. For example, the image sequence augmentor 140, based on determining that the image frame 112 does not include an object to be modified, that the reference image frame 152 does not include a target object, or both, determines that the selection criterion is not satisfied.

In a particular example, the image sequence augmentor 140, in response to determining that the reference image frame 152 satisfies the selection criterion, at 206, uses the reference image frame 152 as the additional image frame corresponding to the image frame 112, at 208. For example, the image sequence augmentor 140 provides the reference image frame 152 to the combiner 124, and the combiner 124 adds the reference image frame 152 to the augmented sequence of image frames 142.

Alternatively, the image sequence augmentor 140, in response to determining that the selection criterion is not satisfied, at 206, refrains from adding an additional image frame 122 corresponding to the image frame 112 in the augmented sequence of image frames 142, at 210. In some examples, the image sequence augmentor 140 provides the image frame 112 to the combiner 124, and the combiner 124 adds the image frame 112 to the augmented sequence of image frames 142. The operations 200 return to 202 to process a next image frame, if any, of the sequence of image frames 112.

In some alternate embodiments, the generation criterion includes the selection criterion. For example, the image sequence augmentor 140 may determine that the generation criterion is satisfied based on determining that no stored image frame satisfies a selection criterion to be used as an additional image frame 122 corresponding to the image frame 112. A technical advantage of the operations 200 can include selectively using the generative AI model 120 to generate an additional image frame 122. For example, the image sequence augmentor 140 can conserve resources (e.g., computing cycles, battery life, network availability, etc.) when the generation criterion is not satisfied, the selection criterion is satisfied, or both.

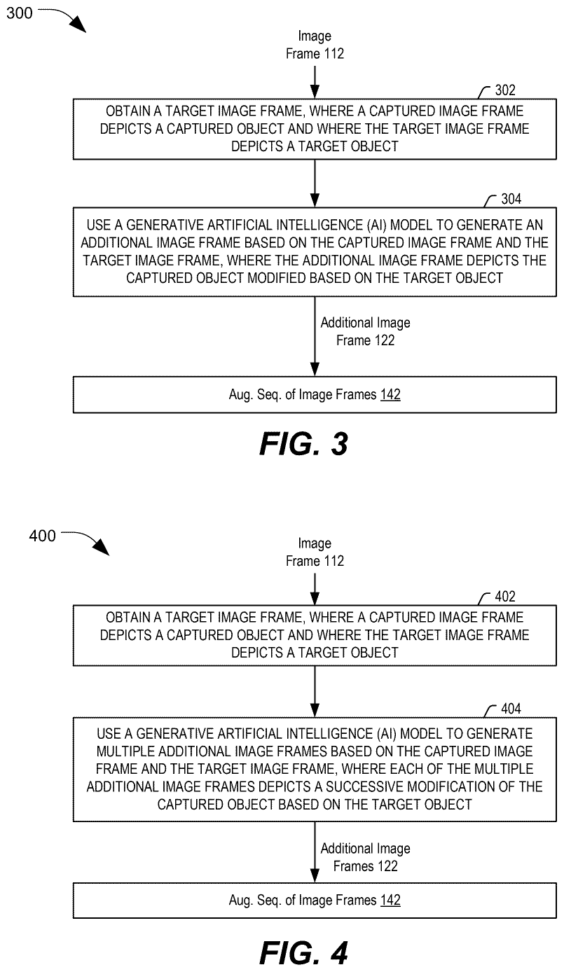

FIG. 3 is a diagram of an illustrative aspect of operations 300 associated with generative AI based image frame sequence augmentation that may be performed by the device 102 (e.g., the processor(s) 190) of FIG. 1, in accordance with some examples of the present disclosure. In some aspects, one or more of the operations 300 can be performed in addition to or as an alternative to various operations described herein, such as one or more of the operations 200 of FIG. 2.

With reference to FIGS. 1-3, the image sequence augmentor 140 obtains a target image frame, at 302. For example, an image frame 112 of the sequence of image frames 112 depicts a captured object (e.g., the person 180 with eyes closed). The image sequence augmentor 140 selects a target image frame (e.g., a reference image frame 152, another image frame 112, or a previously generated additional image frame 122) that depicts a target object (e.g., the person 180 with eyes open), as described with reference to FIGS. 1-2.

At 304, the image sequence augmentor 140 uses the generative AI model 120 to generate an additional image frame 122 based on the image frame 112 and the target image frame, as described with reference to FIG. 1. The additional image frame 122 depicts the captured object modified based on the target object (e.g., the person 180 in the scene 184 with eyes open). The image sequence augmentor 140 provides the additional image frame 122 to the combiner 124, and the combiner 124 adds the additional image frame 122 to the augmented sequence of image frames 142.

A technical advantage of the operations 300 includes the ability to generate an additional image frame 122 that depicts an alternative (e.g., modified) version of a captured object than is depicted in an image frame 112, where the alternative version is based on a target object that is depicted in a target image frame. In some examples, the captured object is replaced by the target object in the additional image frame 122. In some examples, the captured object is not fully replaced by the target object but is altered based on the target object. The target image frame can be a previously generated additional image frame 122, another image frame 112, or a reference image frame 152. In an example, if none of the sequence of image frame 112 depicts the person 180 with open eyes and the target image frame depicts the person 180 (or another person) with open eyes, the target image frame can be used to generate the additional image frame 122 depicting at least partially open eyes that have better quality (e.g., are more realistic).

FIG. 4 is a diagram of an illustrative aspect of operations 400 associated with generative AI based image frame sequence augmentation that may be performed by the device 102 (e.g., the processor(s) 190) of FIG. 1, in accordance with some examples of the present disclosure. In some aspects, one or more of the operations 400 can be performed in addition to or as an alternative to various operations described herein, such as one or more of the operations 200 of FIG. 2, one or more of the operations 300 of FIG. 3, or a combination thereof.

With reference to FIGS. 1-4, the image sequence augmentor 140 obtains a target image frame, at 402. For example, an image frame 112 of the sequence of image frames 112 depicts a captured object (e.g., the face of the person 180). The image sequence augmentor 140 selects a target image frame (e.g., a reference image frame 152, another image frame 112, or a previously generated additional image frame 122) that depicts a target object (e.g., the face of a cat), as described with reference to FIGS. 1-2. In some aspects, the image sequence augmentor 140 selects the target image frame responsive to receipt of a user input 188 that indicates the target object, the target image frame, or both.

At 404, the image sequence augmentor 140 uses the generative AI model 120 to generate multiple additional image frames 122 based on the image frame 112 and the target image frame, as described with reference to FIG. 1. In some examples, each of the additional image frames 122 depicts a successive modification of the captured object based on the target object. For example, the face of the person 180 transitions to the face of a cat over the multiple additional image frames 122. In another example, one or more of the additional image frames 122 depict a natural transition of the person 180 from having closed eyes to having open eyes, the person 180 with eyes fully open, the person 180 with eyes squinting when the person 180 is smiling, and so on. The image sequence augmentor 140 provides the additional image frames 122 to the combiner 124 and the combiner 124 adds the additional image frames 122 to the augmented sequence of image frames 142.

A technical advantage of the operations 400 can include the ability to generate multiple additional image frames 122 that depict alternative versions of the captured object than is depicted in an image frame 112, where the alternative versions are based at least in part on a target object that is depicted in a target image frame. In some examples, the alternative versions correspond to a successive modification of the captured object over multiple image frames of the additional image frames 122. In some aspects, the user 182 can select one of the additional image frames 122 as a preferred image frame (e.g., a thumbnail image).

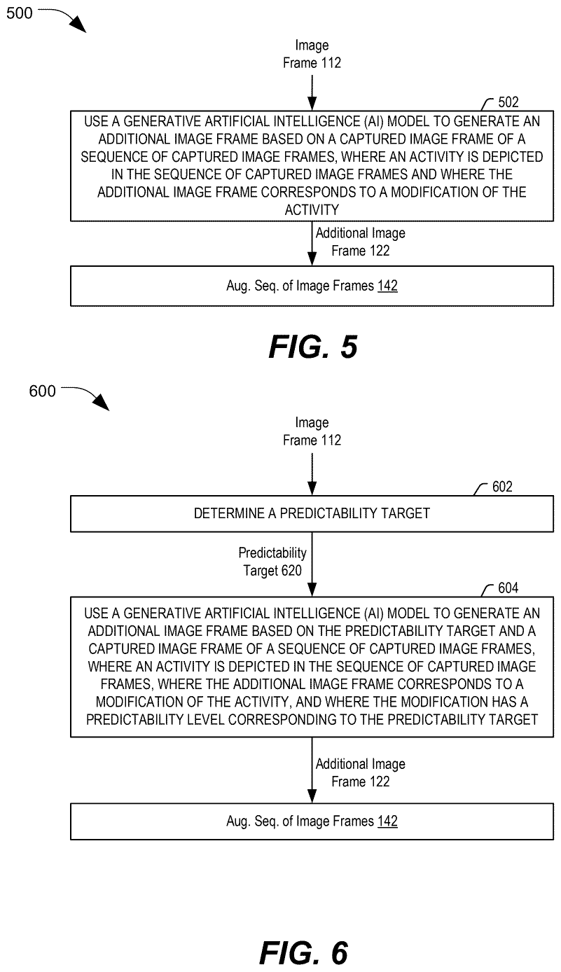

FIG. 5 is a diagram of an illustrative aspect of operations 500 associated with generative AI based image frame sequence augmentation that may be performed by the device 102 (e.g., the processor(s) 190) of FIG. 1, in accordance with some examples of the present disclosure. In some aspects, one or more of the operations 500 can be performed in addition to or as an alternative to various operations described herein, such as one or more of the operations 200 of FIG. 2, one or more of the operations 300 of FIG. 3, one or more of the operations 400 of FIG. 4, or a combination thereof.

With reference to FIGS. 1-5, at 502, the image sequence augmentor 140 uses the generative AI model 120 to generate an additional image frame 122 based on an image frame 112 of the sequence of image frames 112, as described with reference to FIG. 1. An activity (e.g., missing a basket) is depicted in the sequence of image frames 112. The image sequence augmentor 140 generates one or more additional image frames 122 that correspond to a modification of the activity (e.g., scoring the basket). The image sequence augmentor 140 provides the additional image frame(s) 122 to the combiner 124, and the combiner 124 adds the additional image frame(s) 122 to the augmented sequence of image frames 142. In some examples, the combiner 124 does not include (or removes) a subset of the sequence of image frames 112 in the augmented sequence of image frames 142 that correspond to the activity (e.g., missing the basket). The augmented sequence of image frames 142 may include a subset of the sequence of image frames 112 (e.g., shooting the ball and the ball in mid-air flying towards the basket) prior to the activity, a subset of the sequence of image frames 112 after the activity, or both.

A technical advantage of the operations 500 can include generation of the additional image frame 122, which may be part of a sequence of additional image frames 122, depicting modification of an activity. For example, resources (e.g., time of the person 180, cost of capturing an image of the person 180, or both) can be conserved by not having the person 180 perform the modification to the activity for capture with an image capture device 110. Additionally, the operations 500 can include generation of additional image frame(s) 122 that depict modifications that are not feasible to perform in real life (e.g., a different outcome of a basketball game that has finished, scoring a basket by the person 180 who cannot jump high enough to reach the basket, etc.).

FIG. 6 is a diagram of an illustrative aspect of operations 600 associated with generative AI based image frame sequence augmentation that may be performed by the device 102 (e.g., the processor(s) 190) of FIG. 1, in accordance with some examples of the present disclosure. In some aspects, one or more of the operations 600 can be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, or a combination thereof.

With reference to FIGS. 1-6, the image sequence augmentor 140 determines a predictability target, at 602. For example, the image sequence augmentor 140 determines a predictability target 620 based on a user input 188, a configuration setting, a context, or a combination thereof. The predictability target 620 can include a randomness target, a plausibility target, or both.

At 604, the image sequence augmentor 140 uses the generative AI model 120 to generate an additional image frame 122 based on an image frame 112 of the sequence of image frames 112 and the predictability target 620, as described with reference to FIG. 1. An activity (e.g., jumping) is depicted in the sequence of image frames 112. The additional image frame 122 corresponds to a modification of the activity (e.g., jumping higher). The modification has a predictability level (e.g., a randomness level, a plausibility level, or both) corresponding to the predictability target 620. For example, if the predictability target 620 (e.g., the plausibility target) indicates high plausibility, the modification is plausible (e.g., jumping two inches higher). As another example, if the predictability target 620 (e.g., the plausibility target) indicates low or no plausibility, the modification is implausible (e.g., jumping to the moon). In another example, if the predictability target 620 (e.g., the randomness target) indicates low randomness or no randomness, the modification is not random (e.g., a predictable continuation of a depicted activity, such as keep walking in the same direction). Alternatively, if the predictability target 620 (e.g., the randomness target) indicates high randomness, the modification is highly random (e.g., change directions to walk in a random direction). The image sequence augmentor 140 provides the additional image frame 122, which may be part of a sequence of additional image frames 122 corresponding to the modification of the activity, to the combiner 124, and the combiner 124 adds the additional image frame 122 to the augmented sequence of image frames 142.

A technical advantage of the operations 600 includes the ability to control the modification of the activity based on a predictability target (e.g., randomness target, plausibility target, or both). For example, the user 182 can provide a user input 188 indicating the predictability target to control the modification of the activity.

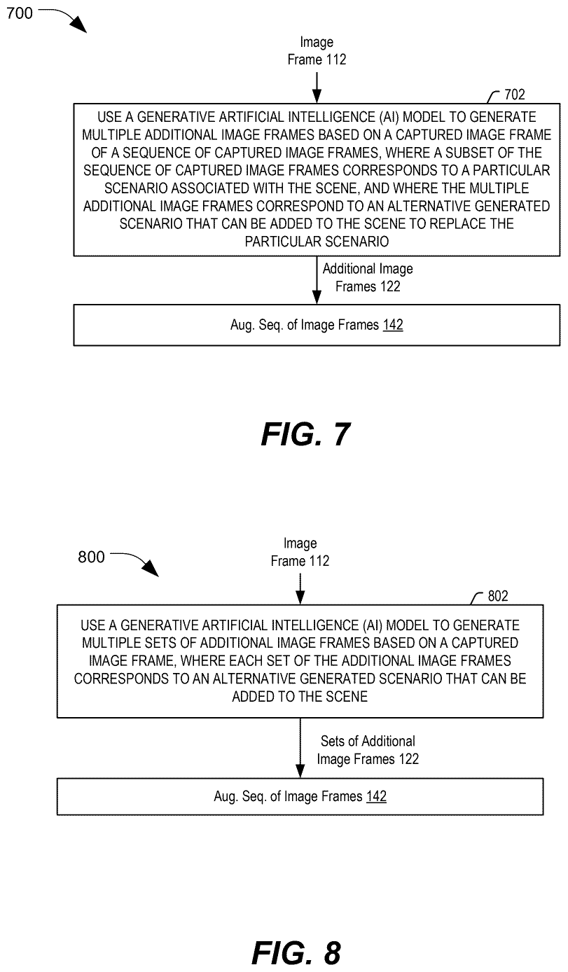

FIG. 7 is a diagram of an illustrative aspect of operations 700 associated with generative AI based image frame sequence augmentation that may be performed by the device 102 (e.g., the processor(s) 190) of FIG. 1, in accordance with some examples of the present disclosure. In some aspects, one or more of the operations 700 can be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, or a combination thereof.

With reference to FIGS. 1-7, at 702, the image sequence augmentor 140 uses the generative AI model 120 to generate multiple additional image frames 122 based on an image frame 112 of the sequence of image frames 112, as described with reference to FIG. 1. A subset of the sequence of image frames 112 corresponds to a particular scenario (e.g., missing a basket or having a picnic in a park) associated with the scene 184. The multiple additional image frames 122 correspond to an alternative generated scenario (e.g., scoring the basket or changing the park to a beach) that can be added to the scene 184 to replace the particular scenario.

The image sequence augmentor 140 provides the additional image frames 122 to the combiner 124, and the combiner 124 adds the additional image frames 122 to the augmented sequence of image frames 142.

A technical advantage of the operations 700 can include generation of the additional image frames 122 depicting an alternative generated scenario. For example, resources (e.g., time of the person 180, cost of capturing an image of the person 180, or both) can be conserved by not having to perform the alternative scenario. Additionally, alternative scenarios can be generated that are not feasible in real life (e.g., because they would defy the laws of physics, would be dangerous, would be cost-prohibitive, etc.).

FIG. 8 is a diagram of an illustrative aspect of operations 800 associated with generative AI based image frame sequence augmentation that may be performed by the device 102 (e.g., the processor(s) 190) of FIG. 1, in accordance with some examples of the present disclosure. In some aspects, one or more of the operations 800 can be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, or a combination thereof.

With reference to FIGS. 1-8, at 802, the image sequence augmentor 140 uses the generative AI model 120 to generate multiple sets of additional image frames 122 based on an image frame 112 of the sequence of image frames 112, as described with reference to FIG. 1. Each set of additional image frames 122 corresponds to an alternative generated scenario (e.g., an office behind a closed door or the moon behind the closed door) that can be added to the scene 184 (e.g., the person 180 walking towards a closed door). Optionally, in some embodiments, each of the sets of the additional image frames 122 has a predictability level that corresponds to a respective predictability target, as described with reference to FIG. 1.

The image sequence augmentor 140 provides the sets of additional image frames 122 to the combiner 124, and the combiner 124 adds the sets of additional image frames 122 to the augmented sequence of image frames 142. In some aspects, the combiner 124 provides the augmented sequence of image frames 142 with the multiple sets of additional image frames 122 to the display device 160, and the interface generator 144 provides a user interface 186 to the display device 160 that includes a menu option to select one of the sets of the additional image frames 122 to keep in the augmented sequence of image frames 142 and remove the remaining sets of additional image frames 122. The image sequence augmentor 140, responsive to receipt of a user input 188 indicating a selection of the menu option, retains the selected set of the additional image frames 122 in the augmented sequence of image frames 142 and removes the remaining sets of the additional image frames 122.

A technical advantage of the operations 800 can include generation of the multiple sets of additional image frames 122 with each set depicting an alternative generated scenario. For example, resources (e.g., time of the person 180, cost of capturing an image of the person 180, or both) can be conserved by not having to perform each of the alternative scenarios and the user 182 can select one of the alternative generated scenarios to include in the augmented sequence of image frames 142. Additionally, alternative scenarios can be generated that are not feasible in real life.

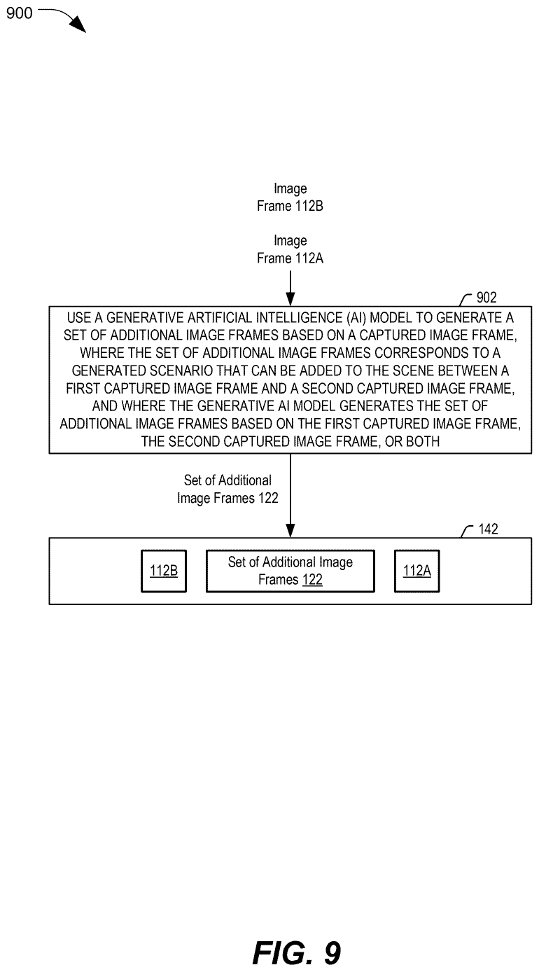

FIG. 9 is a diagram of an illustrative aspect of operations 900 associated with generative AI based image frame sequence augmentation that may be performed by the device 102 (e.g., the processor(s) 190) of FIG. 1, in accordance with some examples of the present disclosure. In some aspects, one or more of the operations 900 can be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, or a combination thereof.

With reference to FIGS. 1-9, at 902, the image sequence augmentor 140 uses the generative AI model 120 to generate a set of additional image frames 122 based on an image frame 112A of the sequence of image frames 112, as described with reference to FIG. 1. The set of additional image frames 122 corresponds to a generated scenario (e.g., crossing a finish line) that can be added to the scene 184 between the image frame 112A (e.g., the person 180 running towards the finish line) and an image frame 112B (e.g., the person 180 after the finish line). The image sequence augmentor 140 provides the set of additional image frames 122 to the combiner 124, and the combiner 124 adds the set of additional image frames 122 to the augmented sequence of image frames 142 between the image frame 112A and the image frame 112B. In some aspects, the image sequence augmentor 140 uses the generative AI model 120 to generate the set of additional image frames 122 based on the image frame 112A and the image frame 112B.

A technical advantage of generating the set of additional image frames 122 based on the image frame 112A can include a seamless transition between the image frame 112A and the set of additional image frames 122. A technical advantage of generating the set of additional image frames 122 additionally based on the image frame 112B can include a seamless transition between the set of additional image frames 122 and the image frame 112B.

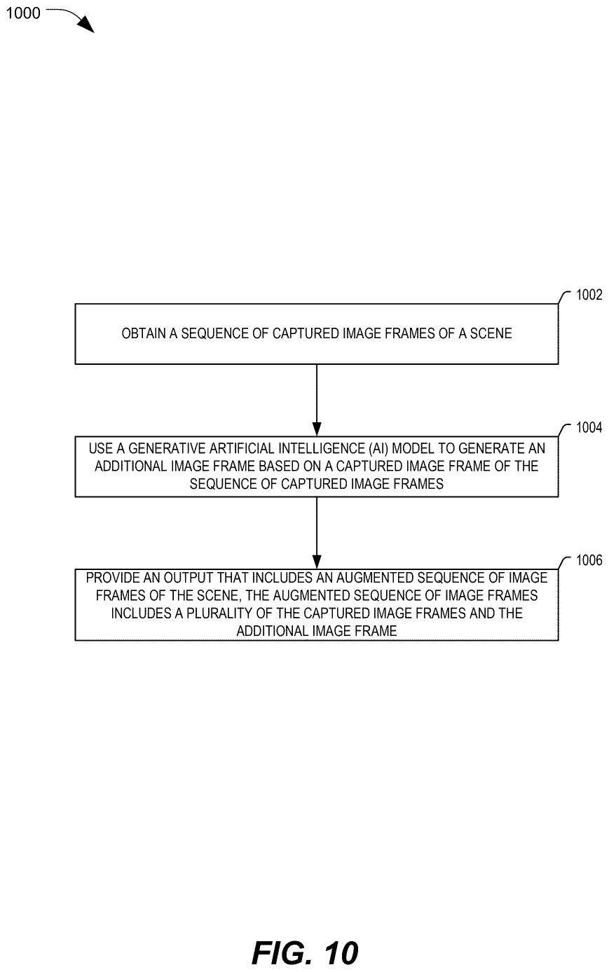

Referring to FIG. 10, a particular implementation of a method 1000 of performing generative AI based image frame sequence augmentation is shown. In a particular aspect, one or more operations of the method 1000 are performed by at least one of the generative AI model 120, the combiner 124, the interface generator 144, the image sequence augmentor 140, the one or more processors 190, the device 102, the system 100 of FIG. 1, or a combination thereof. In some aspects, one or more of the operations of the method 1000 be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, or a combination thereof.

The method 1000 includes obtaining a sequence of captured image frames of a scene, at 1002. For example, the image sequence augmentor 140 of FIG. 1 obtains the sequence of image frames 112 from the image capture device 110 of a scene 184, as described with reference to FIG. 1.

The method 1000 also includes using a generative artificial intelligence (AI) model to generate an additional image frame based on a captured image frame of the sequence of captured image frames, at 1004. For example, the image sequence augmentor 140 uses the generative AI model 120 to generate at least an additional image frame 122 based on at least an image frame 112 of the sequence of image frames 112.

The method 1000 further includes providing an output that includes an augmented sequence of image frames of the scene, at 1006. For example, the image sequence augmentor 140 provides the output 162 that includes the augmented sequence of image frames 142 of the scene 184. In some examples, the augmented sequence of image frames 142 includes a plurality of the image frames 112 and at least one additional image frame 122.

The method 1000 enables augmenting the sequence of image frames 112 with one or more additional image frames 122 to generate the augmented sequence of image frames 142. The augmented sequence of image frames 142 can correspond to an interpolation, an extrapolation, a modification, or a combination thereof, of an activity depicted in the sequence of image frames 112. In some examples, the augmented sequence of image frames 142 can include one or more generated scenarios.

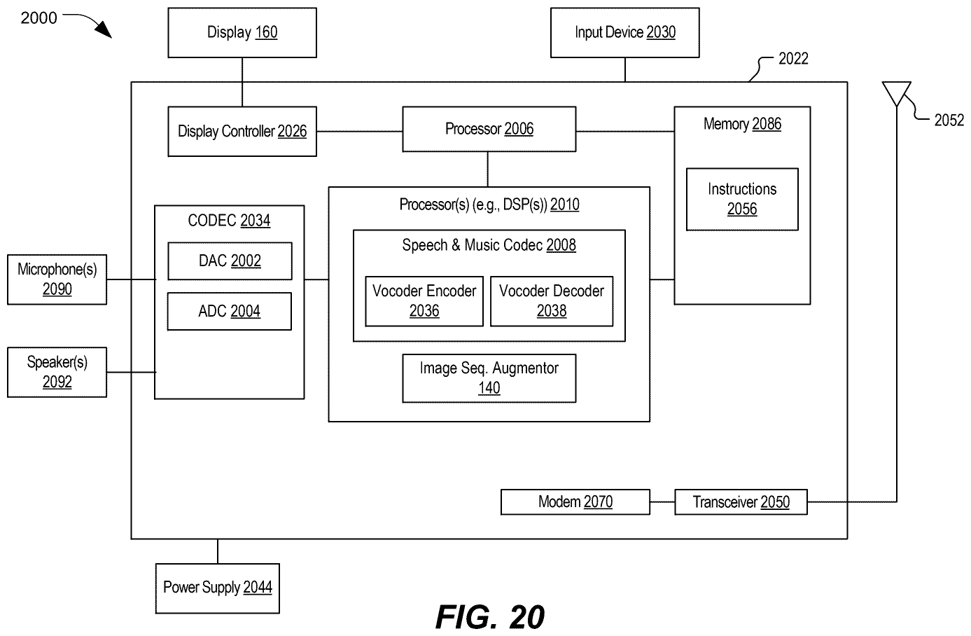

The method 1000 of FIG. 10 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1000 of FIG. 10 may be performed by a processor that executes instructions, such as described with reference to FIG. 20.

FIG. 11 is a diagram of an illustrative aspect of operations 1100 associated with generative AI based image frame sequence augmentation that may be performed by the device 102 (e.g., the processor(s) 190) of FIG. 1, in accordance with some examples of the present disclosure. In some aspects, one or more of the operations 1100 can be performed in addition to or as an alternative to various operations described herein, such as one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, or a combination thereof. In a particular aspect, one or more of the operations 1100 correspond to block 1004 of the method 1000 of FIG. 10.

At 1102, the image sequence augmentor 140 uses the generative AI model 120 to generate an additional image frame 122 based on an image frame 112 of the sequence of image frames 112, as described with reference to FIG. 1. In some examples, the image sequence augmentor 140 provides the additional image frame 122 to the combiner 124, and the combiner 124 adds the additional image frame 122 to the augmented sequence of image frames 142. In some examples, the combiner 124 also adds the image frame 112 to the augmented sequence of image frames 142.

At 1104, the image sequence augmentor 140 determines whether to continue generating more additional image frames 122. For example, the image sequence augmentor 140 determines whether to continue based on a configuration setting, a user input, default data, or a combination thereof. In some examples, the combiner 124 provides one or more image frames (e.g., a previously generated additional image frame 122) of the augmented sequence of image frames 142 as an output 162 to the display device 160, and the interface generator 144 provides the user interface 186 to the display device 160 concurrently with the combiner 124 providing the output 162 to the display device 160. In some of these examples, when the user 182 provides a user input 188 to continue scrolling through successive frames of the augmented sequence of image frames 142 displayed at the display device 160 (e.g., via using a graphical user interface control), even after a final frame (e.g., a most recently added frame) of the augmented sequence of image frames 142 has been displayed, the image sequence augmentor 140 may determine that the user 182 wishes to extend the augmented sequence of image frames 142 with one or more additional image frames 122, and may therefore determine to continue generating more additional image frames 122, at 1104.

In a particular example, the image sequence augmentor 140 based on a user input 188 (e.g., the user 182 selects an option using the user interface 186), a configuration setting, default data, or a combination thereof, determines that more additional image frames 122 are not to be generated, at 1104, and that generation of the augmented sequence of image frames 142 is completed. In some aspects, based on determining that generation of the augmented sequence of image frames 142 is completed, the combiner 124 provides the output 162 including the augmented sequence of image frames 142 to the display device 160, at 1106.

Alternatively, the image sequence augmentor 140, based on determining that generation of more additional image frames 122 is to be continued, at 1104, uses the generative AI model 120 to generate a sequentially next additional image frame 122 based on the most recently generated additional image frame 122, at 1108. For example, a scenario added to the scene 184 in the most recently generated additional image frame 122 can be continued in the sequentially next additional image frame 122. As another example, a first scenario is added to the scene 184 in the most recently generated additional image frame 122 and a second scenario that can follow the first scenario is added to the scene 184 in the sequentially next additional image frame 122.

The image sequence augmentor 140 provides the additional image frame 122 to the combiner 124 and the combiner 124 adds the additional image frame 122 to the augmented sequence of image frames 142 in the output 162, at 1110, and the operations 1100 return to 1104. In some aspects, the combiner 124 provides the additional image frame 122 as part of the output 162 to the display device 160.

A technical advantage of generating the sequentially next additional image frame 122 based on the most recently generated additional image frame 122 includes selectively continuing the scene 184. For example, resources (e.g., computing cycles, time, battery life, etc.) can be conserved if the user 182 determines that generation of more additional image frame 122 is not to be continued.

In some embodiments, two or more of the operations 200-1100 can be combined. In an illustrative non-limiting example, the image sequence augmentor 140 can generate the augmented sequence of image frames 142 that includes a modification of an activity depicted in an image frame 112, as described with reference to FIG. 5, and also include multiple sets of additional image frames 122 that correspond to a continuation of a scenario subsequent to another image frame 112, as described with reference to FIG. 7. In other examples, the image sequence augmentor 140 can perform other combinations of two or more of the operations described herein.

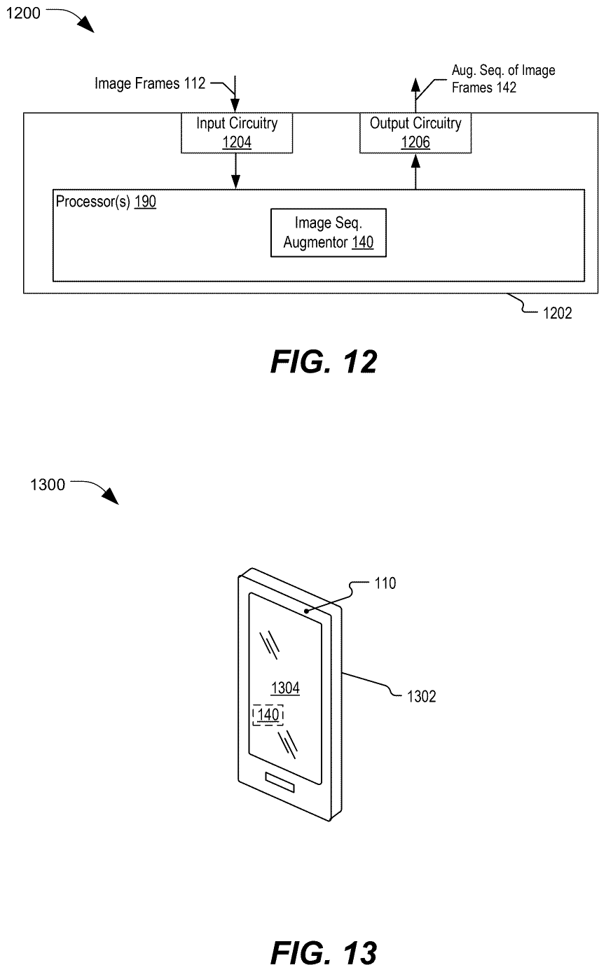

FIG. 12 depicts an implementation 1200 of the device 102 as an integrated circuit 1202 that includes the one or more processors 190. In a particular aspect, the integrated circuit 1202 is configured to perform one or more operations described herein. For example, the integrated circuit 1202 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The processor(s) 190 include the image sequence augmentor 140. The integrated circuit 1202 also includes input circuitry 1204, such as one or more bus interfaces, to enable the sequence of image frames 112 to be received for processing. The integrated circuit 1202 also includes output circuitry 1206, such as a bus interface, to enable sending of the augmented sequence of image frames 142. The integrated circuit 1202 enables implementation of generative AI based image frame sequence augmentation as a component in a system that includes an image capture device, a display device, or both, such as a mobile phone or tablet as depicted in FIG. 13, a wearable electronic device as depicted in FIG. 14, a mixed reality or augmented reality glasses device, as described with reference to FIG. 15, a camera as depicted in FIG. 16, a virtual reality, mixed reality, or augmented reality headset as depicted in FIG. 17, or a vehicle as depicted in FIG. 18 or FIG. 19. Any one or more of the devices of FIGS. 13-19 can include the device 102 (e.g., of FIGS. 1 and 11) and/or used with one or more of the operations 200-1100.

FIG. 13 depicts an implementation 1300 in which the device 102 includes a mobile device 1302, such as a phone or tablet, as illustrative, non-limiting examples. In a particular aspect, the mobile device 1302 is configured to perform one or more operations described herein. For example, the mobile device 1302 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The mobile device 1302 includes the image capture device 110 and a display screen 1304. Components of the processor(s) 190, including the image sequence augmentor 140, are integrated in the mobile device 1302 and are illustrated using dashed lines to indicate internal components that are not generally visible to a user of the mobile device 1302. In a particular example, the image sequence augmentor 140 operates to generate the augmented sequence of image frames 142, which is then processed to perform one or more operations at the mobile device 1302, such as to launch a graphical user interface or otherwise display at least one additional image frame 122 at the display screen 1304.

FIG. 14 depicts an implementation 1400 in which the device 102 includes a wearable electronic device 1402, illustrated as a “smart watch.” In a particular aspect, the wearable electronic device 1402 is configured to perform one or more operations described herein. For example, the wearable electronic device 1402 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The image sequence augmentor 140 and the image capture device 110 are integrated into the wearable electronic device 1402. In a particular example, the image sequence augmentor 140 operates to generate the augmented sequence of image frames 142, which is then processed to perform one or more operations at the wearable electronic device 1402, such as to launch a graphical user interface or otherwise display at least an additional image frame 122 at a display screen 1404 of the wearable electronic device 1402. To illustrate, the wearable electronic device 1402 may include a display screen that is configured to display at least one additional image frame 122. In a particular example, the wearable electronic device 1402 includes a haptic device that provides a haptic notification (e.g., vibrates) in response to display of an image frame. For example, the haptic notification can cause a user to look at the wearable electronic device 1402 to see a displayed image frame. The wearable electronic device 1402 can thus alert a user with a hearing impairment or a user wearing a headset that an image frame is displayed.

FIG. 15 depicts an implementation 1500 in which the device 102 includes a portable electronic device that corresponds to augmented reality or mixed reality glasses 1502. In a particular aspect, the glasses 1502 are configured to perform one or more operations described herein. For example, the glasses 1502 are configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The glasses 1502 include a holographic projection unit 1504 configured to project visual data onto a surface of a lens 1506 or to reflect the visual data off of a surface of the lens 1506 and onto the wearer's retina. The image sequence augmentor 140, the image capture device 110, or both, are integrated into the glasses 1502. The image sequence augmentor 140 may function to generate the augmented sequence of image frames 142 based on a sequence of image frames 112. In some aspects, the sequence of image frames 112 is received from the image capture device 110. In a particular example, the holographic projection unit 1504 is configured to display at least an additional image frame 122. For example, the at least one additional image frame 122 can be superimposed on the user's field of view at a particular position that coincides with the location of a source of a sound associated with an audio event. To illustrate, the sound may be perceived by the user as emanating from the direction of the additional image frame 122.

FIG. 16 depicts an implementation 1600 in which the device 102 includes a portable electronic device that corresponds to a camera device 1602. In a particular aspect, the camera device 1602 is configured to perform one or more operations described herein. For example, the camera device 1602 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The image sequence augmentor 140, the image capture device 110, or both, are included in the camera device 1602. During operation, in response to receiving a verbal command, the camera device 1602 can execute operations responsive to spoken user commands, such as to adjust image or video capture settings, image or video playback settings, or image or video capture instructions, as illustrative examples. The image sequence augmentor 140 may function to generate the augmented sequence of image frames 142 based on a sequence of image frames 112 received from the image capture device 110. In a particular example, at least an additional image frame 122 can be displayed at a display screen (not shown) of the camera device 1602.

FIG. 17 depicts an implementation 1700 in which the device 102 includes a portable electronic device that corresponds to a virtual reality, mixed reality, or augmented reality headset 1702. In a particular aspect, the headset 1702 is configured to perform one or more operations described herein. For example, the headset 1702 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The image sequence augmentor 140 is integrated into the headset 1702. In a particular aspect, the headset 1702 includes the image capture device 110. An augmented sequence of image frames 142 is generated based on a sequence of image frames 112. In some aspects, the sequence of image frames 112 is received from the image capture device 110 of the headset 1702. A visual interface device is positioned in front of the user's eyes to enable display of augmented reality, mixed reality, or virtual reality images or scenes to the user while the headset 1702 is worn. In a particular example, the visual interface device is configured to display at least an additional image frame 122.

FIG. 18 depicts an implementation 1800 in which the device 102 corresponds to, or is integrated within, a vehicle 1802, illustrated as a manned or unmanned aerial device (e.g., a package delivery drone). In a particular aspect, the vehicle 1802 is configured to perform one or more operations described herein. For example, the vehicle 1802 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The image sequence augmentor 140 is integrated into the vehicle 1802. In a particular aspect, the image capture device 110 is integrated into the vehicle 1802. An augmented sequence of image frames 142 is generated based on a sequence of image frames 112. In some aspects, the sequence of image frames 112 is received from the image capture device 110 of the vehicle 1802.

FIG. 19 depicts another implementation 1900 in which the device 102 corresponds to, or is integrated within, a vehicle 1902, illustrated as a car. In a particular aspect, the vehicle 1902 is configured to perform one or more operations described herein. For example, the vehicle 1902 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

The vehicle 1902 includes the processor(s) 190 including the image sequence augmentor 140. In some aspects, the vehicle 1902 also includes the image capture device 110. In some optional embodiments, an image capture device 110 is positioned to capture images of the interior of the vehicle 1902, the exterior of the vehicle 1902, or both.

An augmented sequence of image frames 142 is generated based on a sequence of image frames 112. In some aspects, the sequence of image frames 112 is received from the image capture device 110 of the vehicle 1902. In some aspects, at least an additional image frame 122 is displayed at a display device 1920 of the vehicle 1902.

Referring to FIG. 20, a block diagram of a particular illustrative implementation of a device is depicted and generally designated 2000. In various implementations, the device 2000 may have more or fewer components than illustrated in FIG. 20. In an illustrative implementation, the device 2000 may correspond to the device 102. In an illustrative implementation, the device 2000 may perform one or more operations described with reference to FIGS. 1-19. For example, the device 2000 is configured to perform one or more of the operations 200 of FIG. 2, one or more of the operations 300 of FIG. 3, one or more of the operations 400 of FIG. 4, one or more of the operations 500 of FIG. 5, one or more of the operations 600 of FIG. 6, one or more of the operations 700 of FIG. 7, one or more of the operations 800 of FIG. 8, one or more of the operations 900 of FIG. 9, one or more operations of the method 1000 of FIG. 10, one or more of the operations 1100 of FIG. 11, or a combination thereof.

In a particular implementation, the device 2000 includes a processor 2006 (e.g., a CPU). The device 2000 may include one or more additional processors 2010 (e.g., one or more DSPs). In a particular aspect, the one or more processors 190 of FIG. 1 correspond to the processor 2006, the processors 2010, or a combination thereof. The processors 2010 may include a speech and music coder-decoder (CODEC) 2008 that includes a voice coder (“vocoder”) encoder 2036, a vocoder decoder 2038, or both. The processors 2010 may include the image sequence augmentor 140.

The device 2000 may include a memory 2086 and a CODEC 2034. In a particular aspect, the memory 2086 includes the memory 132 of FIG. 1. The memory 2086 may include instructions 2056, that are executable by the one or more additional processors 2010 (or the processor 2006) to implement the functionality described with reference to the generative AI model 120, the combiner 124, the interface generator 144, the image sequence augmentor 140, or a combination thereof. The device 2000 may include a modem 2070 coupled, via a transceiver 2050, to an antenna 2052. In a particular aspect, the modem 2070 is configured to receive the sequence of image frames 112 from another device. In a particular aspect, the modem 2070 is configured to transmit the augmented sequence of image frames 142, the user interface 186, the output 162, or a combination thereof, to another device.

The device 2000 may include the display device 160 coupled to a display controller 2026. One or more speakers 2092, one or more microphones 2090, or a combination thereof, may be coupled to the CODEC 2034. The CODEC 2034 may include a digital-to-analog converter (DAC) 2002, an analog-to-digital converter (ADC) 2004, or both. In a particular implementation, the CODEC 2034 may receive analog signals from the one or more microphones 2090, convert the analog signals to digital signals using the analog-to-digital converter 2004, and provide the digital signals to the speech and music codec 2008. The speech and music codec 2008 may process the digital signals. In a particular implementation, the speech and music codec 2008 may provide digital signals to the CODEC 2034. The CODEC 2034 may convert the digital signals to analog signals using the digital-to-analog converter 2002 and may provide the analog signals to the one or more speakers 2092.

In a particular implementation, the device 2000 may be included in a system-in-package or system-on-chip device 2022. In a particular implementation, the memory 2086, the processor 2006, the processors 2010, the display controller 2026, the CODEC 2034, and the modem 2070 are included in the system-in-package or system-on-chip device 2022. In a particular implementation, an input device 2030 and a power supply 2044 are coupled to the system-in-package or the system-on-chip device 2022. In a particular aspect, the input device 2030 includes the image capture device 110, a keyboard, a mouse, a touchpad, or a combination thereof. Moreover, in a particular implementation, as illustrated in FIG. 20, the display device 160, the input device 2030, the one or more speakers 2092, the one or more microphones 2090, the antenna 2052, and the power supply 2044 are external to the system-in-package or the system-on-chip device 2022. In a particular implementation, each of the display device 160, the input device 2030, the one or more speakers 2092, the one or more microphones 2090, the antenna 2052, and the power supply 2044 may be coupled to a component of the system-in-package or the system-on-chip device 2022, such as an interface or a controller.

The device 2000 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a sequence of captured image frames of a scene. For example, the means for obtaining a sequence of image frames 112 of a scene 184 can correspond to the image capture device 110, the generative AI model 120, the image sequence augmentor 140, the device 102, the system 100 of FIG. 1, the modem 2070, the transceiver 2050, the antenna 2052, the processor 2006, the processor(s) 2010, the system-in-package or system-on-chip device 2022, the device 2000, one or more other circuits or components configured to obtain the sequence of image frames 112, or any combination thereof.

The apparatus also includes means for using a generative artificial intelligence (AI) model to generate a first additional image frame based on a captured image frame of the sequence of captured image frames. For example, the means for using the generative AI model can correspond to the image sequence augmentor 140, the generative AI model 120, the one or more processors 190, the device 102, the system 100 of FIG. 1, the processor 2006, the processor(s) 2010, the system-in-package or system-on-chip device 2022, the device 2000, one or more other circuits or components configured to use a generative AI model, or any combination thereof.

The apparatus further includes means for providing an output that includes an augmented sequence of image frames of the scene, where the augmented sequence of image frames includes a plurality of the captured image frames and the first additional image frame. For example, the means for providing an output can correspond to the generative AI model 120, the combiner 124, the interface generator 144, the image sequence augmentor 140, the display device 160, the device 102, the system 100 of FIG. 1, the modem 2070, the transceiver 2050, the antenna 2052, the processor 2006, the processor(s) 2010, the system-in-package or system-on-chip device 2022, the device 2000, the display controller 2026, one or more other circuits or components configured to provide an output, or any combination thereof.

In some implementations, a non-transitory computer-readable medium (e.g., a computer-readable storage device, such as the memory 2086) includes instructions (e.g., the instructions 2056) that, when executed by one or more processors (e.g., the one or more processors 2010 or the processor 2006), cause the one or more processors to obtain a sequence of captured image frames (e.g., the sequence of image frames 112) of a scene (e.g., the scene 184). The instructions, when executed by the one or more processors, also cause the one or more processors to use a generative artificial intelligence (AI) model (e.g., the generative AI model 120) to generate a first additional image frame (e.g., an additional image frame 122) based on a captured image frame (e.g., an image frame 112) of the sequence of captured image frames. The instructions, when executed by the one or more processors, further cause the one or more processors to provide an output (e.g., the output 162) that includes an augmented sequence of image frames (e.g., the augmented sequence of image frames 142) of the scene, where the augmented sequence of image frames includes a plurality of the captured image frames (e.g., a plurality of the image frames 112) and the first additional image frame.

Particular aspects of the disclosure are described below in sets of interrelated Examples:

According to Example 1, a device includes a memory configured to store a sequence of captured image frames of a scene; and one or more processors coupled to the memory, wherein the one or more processors are configured to use a generative artificial intelligence (AI) model to generate a first additional image frame based on a captured image frame of the sequence of captured image frames; and provide an output that includes an augmented sequence of image frames of the scene, wherein the augmented sequence of image frames includes a plurality of the captured image frames and the first additional image frame.

Example 2 includes the device of Example 1, wherein the augmented sequence of image frames includes the captured image frames.

Example 3 includes the device of Example 1 or Example 2, wherein the one or more processors are configured to, based on a determination that a generation condition is satisfied, use the generative AI model to generate the first additional image frame.

Example 4 includes the device of Example 3, wherein the generation condition is based on a battery level, a network connectivity, a power connectivity, a scheduled time, or a combination thereof.

Example 5 includes the device of Example 3 or Example 4, wherein the one or more processors are configured to, based on a determination that no stored image frame satisfies a selection criterion to be used as the first additional image frame, determine that the generation condition is satisfied.

Example 6 includes the device of any of Examples 1 to 5, wherein the generative AI model is integrated in a remote device, and wherein the one or more processors are configured to receive the first additional image frame from the remote device.

Example 7 includes the device of any of Examples 1 to 6, wherein the captured image frame depicts a captured object, wherein a target image frame depicts a target object, and wherein the first additional image frame depicts the captured object modified based on the target object.

Example 8 includes the device of Example 7, wherein the target image frame corresponds to another captured image frame of the sequence of captured image frames.

Example 9 includes the device of Example 7 or Example 8, wherein the target image frame corresponds to a stored image frame.

Example 10 includes the device of any of Examples 1 to 9, wherein the sequence of captured image frames corresponds to a single image capture operation of an image capture device.

Example 11 includes the device of any of Examples 1 to 10, where an activity is depicted in the sequence of captured image frames, and wherein the first additional image frame corresponds to a modification of the activity.

Example 12 includes the device of Example 11, wherein the modification has a level of predictability that is based on a user input, a configuration setting, a context, or a combination thereof.

Example 13 includes the device of any of Examples 1 to 12, wherein the one or more processors are configured to use the generative AI model to generate multiple additional image frames based on the captured image frame, wherein a subset of the sequence of captured image frames corresponds to a particular scenario associated with the scene, and wherein the multiple additional image frames correspond to an alternative generated scenario that can be added to the scene to replace the particular scenario.

Example 14 includes the device of any of Examples 1 to 13, wherein the one or more processors are configured to use the generative AI model to generate multiple sets of additional image frames based on the captured image frame, and wherein each set of additional image frames corresponds to an alternative generated scenario that can be added to the scene.

Example 15 includes the device of any of Examples 1 to 14, wherein the one or more processors are configured to use the generative AI model to generate a set of additional image frames that corresponds to a generated scenario that can be added to the scene between a first captured image frame and a second captured image frame, and wherein the generative AI model generates the set of additional image frames based on the first captured image frame, the second captured image frame, or both.

Example 16 includes the device of any of Examples 1 to 15, wherein the one or more processors are configured to, responsive to a user input: use the generative AI model to generate a second additional image frame based on the first additional image frame; and add the second additional image frame to the augmented sequence of image frames in the output.

Example 17 includes the device of any of Examples 1 to 16, wherein a first playout duration of the sequence of captured image frames is less than a second playout duration of the augmented sequence of image frames, and wherein the sequence of captured image frames has the same frame rate as the augmented sequence of image frames.

Example 18 includes the device of any of Examples 1 to 17, wherein the sequence of captured image frames includes a reduced quality version of one or more image features, and the first additional image frame includes a higher quality version of the one or more image features.

Example 19 includes the device of any of Examples 1 to 18, wherein the one or more processors are configured to generate a user interface to enable receipt of user instructions regarding generation of the augmented sequence of image frames.

Example 20 includes the device of Example 19, wherein the output indicates the user instructions, an AI attribution tag, or both.

Example 21 includes the device of any of Examples 1 to 20, and the device further includes a camera configured to provide the sequence of captured image frames of the scene.

Example 22 includes the device of any of Examples 1 to 21, and the device further includes a modem configured to send the augmented sequence of image frames to another device.

Example 23 includes the device of any of Examples 1 to 22, and the device further includes a display device configured to display the augmented sequence of image frames.

Example 24 includes the device of any of Examples 1 to 23, wherein the generative AI model is integrated in another device, and wherein the one or more processors are configured to obtain the first additional image frame from the other device.

According to Example 25, a method includes obtaining, at a device, a sequence of captured image frames of a scene; using, at the device, a generative artificial intelligence (AI) model to generate a first additional image frame based on a captured image frame of the sequence of captured image frames; and providing, at the device, an output that includes an augmented sequence of image frames of the scene, wherein the augmented sequence of image frames includes a plurality of the captured image frames and the first additional image frame.

Example 26 includes the method of Example 25, wherein the augmented sequence of image frames includes the captured image frames.

Example 27 includes the method of Example 25 or Example 26, wherein, based on determining that a generation condition is satisfied, the generative AI model is used to generate the first additional image frame.

Example 28 includes the method of Example 27, wherein the generation condition is based on a battery level, a network connectivity, a power connectivity, a scheduled time, or a combination thereof.

Example 29 includes the method of Example 27 or Example 28, wherein determining that the generation condition is satisfied is based on determining that no stored image frame satisfies a selection criterion to be used as the first additional image frame.

Example 30 includes the method of any of Examples 25 to 29, and further includes receiving the first additional image frame from a remote device, wherein the generative AI model is integrated in the remote device.

Example 31 includes the method of any of Examples 25 to 30, wherein the captured image frame depicts a captured object, wherein a target image frame depicts a target object, and wherein the first additional image frame depicts the captured object modified based on the target object.

Example 32 includes the method of Example 31, wherein the target image frame corresponds to another captured image frame of the sequence of captured image frames.

Example 33 includes the method of Example 31 or Example 32, wherein the target image frame corresponds to a stored image frame.

Example 34 includes the method of any of Examples 25 to 33, wherein the sequence of captured image frames corresponds to a single image capture operation of an image capture device.

Example 35 includes the method of any of Examples 25 to 34, where an activity is depicted in the sequence of captured image frames, and wherein the first additional image frame corresponds to a modification of the activity.

Example 36 includes the method of Example 35, wherein the modification has a level of predictability that is based on a user input, a configuration setting, a context, or a combination thereof.

Example 37 includes the method of any of Examples 25 to 36, and further includes using the generative AI model to generate multiple additional image frames based on the captured image frame, wherein a subset of the sequence of captured image frames corresponds to a particular scenario associated with the scene, and wherein the multiple additional image frames correspond to an alternative generated scenario that can be added to the scene to replace the particular scenario.

Example 38 includes the method of any of Examples 25 to 37, and further includes using the generative AI model to generate multiple sets of additional image frames based on the captured image frame, wherein each set of additional image frames corresponds to an alternative generated scenario that can be added to the scene.

Example 39 includes the method of any of Examples 25 to 38, and further includes using the generative AI model to generate a set of additional image frames that corresponds to a generated scenario that can be added to the scene between a first captured image frame and a second captured image frame, wherein the generative AI model generates the set of additional image frames based on the first captured image frame, the second captured image frame, or both.

Example 40 includes the method of any of Examples 25 to 39, and further includes, responsive to a user input: using the generative AI model to generate a second additional image frame based on the first additional image frame; and adding the second additional image frame to the augmented sequence of image frames in the output.

Example 41 includes the method of any of Examples 25 to 40, wherein a first playout duration of the sequence of captured image frames is less than a second playout duration of the augmented sequence of image frames, and wherein the sequence of captured image frames has the same frame rate as the augmented sequence of image frames.

Example 42 includes the method of any of Examples 25 to 41, wherein the sequence of captured image frames includes a reduced quality version of one or more image features, and the first additional image frame includes a higher quality version of the one or more image features.

Example 43 includes the method of any of Examples 25 to 42, and further includes generating a user interface to enable receipt of user instructions regarding generation of the augmented sequence of image frames.

Example 44 includes the method of Example 43, wherein the output indicates the user instructions, an AI attribution tag, or both.

Example 45 includes the method of any of Examples 25 to 44, and further includes receiving, from a camera, the sequence of captured image frames of the scene.

Example 46 includes the method of any of Examples 25 to 45, and further includes sending, via a modem, the augmented sequence of image frames to another device.

Example 47 includes the method of any of Examples 25 to 46, and further includes providing, to a display device, the augmented sequence of image frames.

Example 48 includes the method of any of Examples 25 to 47, and further includes receiving the first additional image frame from another device, wherein the generative AI model is integrated in the other device.

According to Example 49, a non-transitory computer readable medium storing instructions that, when executed by one or more processors, cause the one or more processors to obtain a sequence of captured image frames of a scene; use a generative artificial intelligence (AI) model to generate a first additional image frame based on a captured image frame of the sequence of captured image frames; and provide an output that includes an augmented sequence of image frames of the scene, wherein the augmented sequence of image frames includes a plurality of the captured image frames and the first additional image frame.

According to Example 50, an apparatus includes means for obtaining a sequence of captured image frames of a scene; means for using a generative artificial intelligence (AI) model to generate a first additional image frame based on a captured image frame of the sequence of captured image frames; and means for providing an output that includes an augmented sequence of image frames of the scene, wherein the augmented sequence of image frames includes a plurality of the captured image frames and the first additional image frame.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a sequence of captured image frames of a scene; and
one or more processors coupled to the memory, wherein the one or more processors are configured to:
use a generative artificial intelligence (AI) model to generate a first additional image frame based on a captured image frame of the sequence of captured image frames; and
provide an output that includes an augmented sequence of image frames of the scene, wherein the augmented sequence of image frames includes a plurality of the captured image frames and the first additional image frame.

2. The device of claim 1, wherein the augmented sequence of image frames includes the captured image frames.

3. The device of claim 1, wherein the one or more processors are configured to, based on a determination that a generation condition is satisfied, use the generative AI model to generate the first additional image frame.

4. The device of claim 3, wherein the generation condition is based on a battery level, a network connectivity, a power connectivity, a scheduled time, or a combination thereof.

5. The device of claim 3, wherein the one or more processors are configured to, based on a determination that no stored image frame satisfies a selection criterion to be used as the first additional image frame, determine that the generation condition is satisfied.

6. The device of claim 1, further comprising a modem configured to transmit the first additional image frame to a remote device.

7. The device of claim 1, wherein the captured image frame depicts a captured object, wherein a target image frame depicts a target object, and wherein the first additional image frame depicts the captured object modified based on the target object.

8. The device of claim 7, wherein the target image frame corresponds to another captured image frame of the sequence of captured image frames.

9. The device of claim 7, wherein the target image frame corresponds to a stored image frame.

10. The device of claim 1, wherein the sequence of captured image frames corresponds to a single image capture operation of an image capture device.

11. The device of claim 1, where an activity is depicted in the sequence of captured image frames, and wherein the first additional image frame corresponds to a modification of the activity.

12. The device of claim 11, wherein the modification has a level of predictability that is based on a user input, a configuration setting, a context, or a combination thereof.

13. The device of claim 1, wherein the one or more processors are configured to use the generative AI model to generate multiple additional image frames based on the captured image frame, wherein a subset of the sequence of captured image frames corresponds to a particular scenario associated with the scene, and wherein the multiple additional image frames correspond to an alternative generated scenario that can be added to the scene to replace the particular scenario.

14. The device of claim 1, wherein the one or more processors are configured to use the generative AI model to generate multiple sets of additional image frames based on the captured image frame, and wherein each set of additional image frames corresponds to an alternative generated scenario that can be added to the scene.

15. The device of claim 1, wherein the one or more processors are configured to use the generative AI model to generate a set of additional image frames that corresponds to a generated scenario that can be added to the scene between a first captured image frame and a second captured image frame, and wherein the generative AI model generates the set of additional image frames based on the first captured image frame, the second captured image frame, or both.

16. The device of claim 1, wherein the one or more processors are configured to, responsive to a user input:
use the generative AI model to generate a second additional image frame based on the first additional image frame; and
add the second additional image frame to the augmented sequence of image frames in the output.

17. The device of claim 1, wherein a first playout duration of the sequence of captured image frames is less than a second playout duration of the augmented sequence of image frames, and wherein the sequence of captured image frames has the same frame rate as the augmented sequence of image frames.

18. A method comprising:
obtaining, at a device, a sequence of captured image frames of a scene;
using, at the device, a generative artificial intelligence (AI) model to generate a first additional image frame based on a captured image frame of the sequence of captured image frames; and
providing, at the device, an output that includes an augmented sequence of image frames of the scene, wherein the augmented sequence of image frames includes a plurality of the captured image frames and the first additional image frame.

19. A non-transitory computer readable medium storing instructions that, when executed by one or more processors, cause the one or more processors to:
obtain a sequence of captured image frames of a scene;
use a generative artificial intelligence (AI) model to generate a first additional image frame based on a captured image frame of the sequence of captured image frames; and
provide an output that includes an augmented sequence of image frames of the scene, wherein the augmented sequence of image frames includes a plurality of the captured image frames and the first additional image frame.
